(19) United States
(12) Patent Application Publication
(10) Pub. No.: US 2022/0382964 A1
(43) Pub. Date: Dec. 1, 2022

(54) DISPLAY APPARATUS, DISPLAY SYSTEM, AND DISPLAY METHOD

(71) Applicants: Mitomo MAEDA, Kanagawa (JP); Susumu FUJIOKA, Kanagawa (JP)

(72) Inventors: Mitomo MAEDA, Kanagawa (JP); Susumu FUJIOKA, Kanagawa (JP)

(21) Appl. No.: 17/750,406

(22) Filed: May 23, 2022

(30) Foreign Application Priority Data
May 26, 2021 (JP) 2021-088203
Apr. 8, 2022 (JP) 2022-064290

(51) Int. Cl. G06F 40/166; G10L 15/26; G06F 40/103

(52) U.S. Cl. CPC G06F 40/166; G10L 15/26; G06F 40/103

(57) ABSTRACT

A display apparatus includes circuitry. The circuitry receives an input of hand drafted data with an input device. The circuitry converts the hand drafted data into first text data. The circuitry receives an input of first voice data. The circuitry converts the first voice data into second text data. The circuitry displays, on a display, third text data converted from second voice data in a case that the first text data and the second text data match each other at least in part.

### CROSS-REFERENCE TO RELATED APPLICATIONS

This patent application is based on and claims priority pursuant to 35 U.S.C. § 119(a) to Japanese Patent Application Nos. 2021-088203, filed on May 26, 2021, and 2022-064290, filed on Apr. 8, 2022, in the Japan Patent Office, the entire disclosures of which are hereby incorporated by reference herein.

### BACKGROUND

### Technical Field

Embodiments of this disclosure relate to a display apparatus, a display system, and a display method.

### Related Art

Display apparatuses are known that convert hand drafted input data to a character string (character codes) and display the character string on a screen by using a handwriting recognition technique. A display apparatus having a relatively large touch panel is used in a conference room and is shared by a plurality of users as an electronic whiteboard, for example.

Technologies are known that receive input of text data obtained by performing speech recognition on a speech by a user. For example, technologies are known that correct a recognition result of hand drafted input data using a recognition result obtained by performing speech recognition on a speech, thereby improving character recognition accuracy.

### SUMMARY

An embodiment of the present disclosure includes a display apparatus including circuitry. The circuitry receives an input of hand drafted data with an input device. The circuitry converts the hand drafted data into first text data. The circuitry receives an input of first voice data. The circuitry converts the first voice data into second text data. The circuitry displays, on a display, third text data converted from second voice data in a case that the first text data and the second text data match each other at least in part.

Another embodiment of the present disclosure includes a display system including circuitry. The circuitry receives an input of hand drafted data with an input device. The circuitry converts the hand drafted data into first text data. The circuitry receives an input of first voice data. The circuitry converts the first voice data into second text data. The circuitry displays third text data converted from second voice data in a case that the first text data and the second text data match each other at least in part.

Another embodiment of the present disclosure includes a display method. The method includes receiving an input of hand drafted data with an input device. The method includes converting the hand drafted data into first text data. The method includes receiving an input of first voice data. The method includes converts the first voice data into second text data. The method includes displaying third text data converted from second voice data in a case that the first text data and the second text data match each other at least in part.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an overview of an operation performed by a display apparatus of displaying text data obtained by performing speech recognition on a speech by a speaker, according to an embodiment of the present disclosure;

FIG. 2 is a block diagram illustrating an example of a hardware configuration of the display apparatus, according to an embodiment of the present disclosure;

FIG. 3 is a diagram illustrating an example of a hardware configuration of a contact sensor, according to an embodiment of the present disclosure;

FIG. 4 is a block diagram illustrating an example of a functional configuration of the display apparatus, according to an embodiment of the present disclosure;

FIG. 5 is a diagram illustrating an example of input data stored in an input data storage unit, according to an embodiment of the present disclosure;

FIG. 6 is a diagram illustrating an example of an initial screen displayed by the display apparatus, according to an embodiment of the present disclosure;

FIG. 7 is a diagram illustrating how a character size is calculated, according to an embodiment of the present disclosure;

FIG. 8A to FIG. 8C are diagrams illustrating how to calculate a font size of cursive or print, according to an embodiment of the present disclosure;

FIG. 9 is a table indicating, for each of lines, the number of pixels of “today” on the lines that horizontally slice a rectangle, according to an embodiment of the present disclosure;

FIG. 10 is a diagram illustrating an example of a voice input mark, according to an embodiment of the present disclosure;

FIG. 11 is a diagram illustrating an example of the voice input mark moved to the right of “Today's agenda”, according to an embodiment of the present disclosure;

FIG. 12A is a flowchart (1) illustrating an example of an operation performed by the display apparatus of receiving input of text data obtained by performing character recognition on hand drafted data and text data obtained by performing speech recognition on voice data, according to an embodiment of the present disclosure;

FIG. 12B is a flowchart (2) illustrating an example of an operation performed by the display apparatus of receiving input of text data obtained by performing character recognition on hand drafted data and text data obtained by performing speech recognition on voice data, according to an embodiment of the present disclosure;

FIG. 13 is a diagram illustrating an example of the voice input mark is erased, according to an embodiment of the present disclosure;

FIG. 14 is a diagram illustrating an example in which a voice input mark is moved, according to an embodiment of the present disclosure;

FIG. 15 is a diagram illustrating an example of the voice input mark displayed to the right of “(1)”, according to an embodiment of the present disclosure;

FIG. 16 is a diagram illustrating an example of a screen on which text data “Planning” and the voice input mark are displayed to the right of “(1)”, according to an embodiment of the present disclosure;

FIG. 17 is a schematic diagram illustrating an example of a configuration of a display system, according to an embodiment of the present disclosure;

FIG. 18 is a diagram illustrating an example of a hardware configuration of a server apparatus, according to an embodiment of the present disclosure; and

FIG. 19 is a block diagram illustrating an example of functional configurations of the display apparatus and the server apparatus, according to an embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of a display apparatus and a display method performed by the display apparatus according to one or more embodiments of the present disclosure, with reference to the attached drawings.

### First Embodiment

Supplementary Information Regarding Hand Drafted Input and Voice Input:

A work of drafting characters or drawings by an input device on a display apparatus such as an electronic whiteboard places burden to a writer (a user who drafts characters or drawings with an input device). For example, the writer's hand gets tired, or it takes time for the writer to draft characters or drawings with an input device. To address such an issue, there is a demand to input characters by voice instead of handwriting.

However, in this case, the following issues are to be addressed.

1. It is assumed that in a state where a writer such as a chairperson who drafts characters or drawings on the display apparatus with an input device is going to input characters using speech recognition, a person different from the chairman starts to speak. In this case, the voice of the different person is converted into text data by speech recognition and the text data is displayed on the display apparatus.

For the purpose of avoiding this inconvenience, a method may be selected in which the display apparatus displays a list of participants of a conference according to the writer's instruction and the writer selects a desired participant whose voices to be subjected to speech recognition. However, the writer has to select the desired participant each time characters are to be input by voice, and this operation takes time and effort.

2. The writer has to designate a position where text data converted from voice by speech recognition is to be displayed. If the writer does not designate any position where the text data is to be displayed, the text data is displayed at a default display position (e.g., the upper left of the screen).

3. When the display apparatus displays text data converted from voice by speech recognition, the text data is displayed in a default size unless the size of characters is designated in advance. When characters are to be displayed in a size other than the default size, the writer has to designate the size of characters from a menu or the like in advance (before the speaker speaks), and this operation takes time and effort.

Overview of Operation:

In view of such issues, in the present embodiment, a method described below allows the writer to input characters by voice instead of hand drafted input.

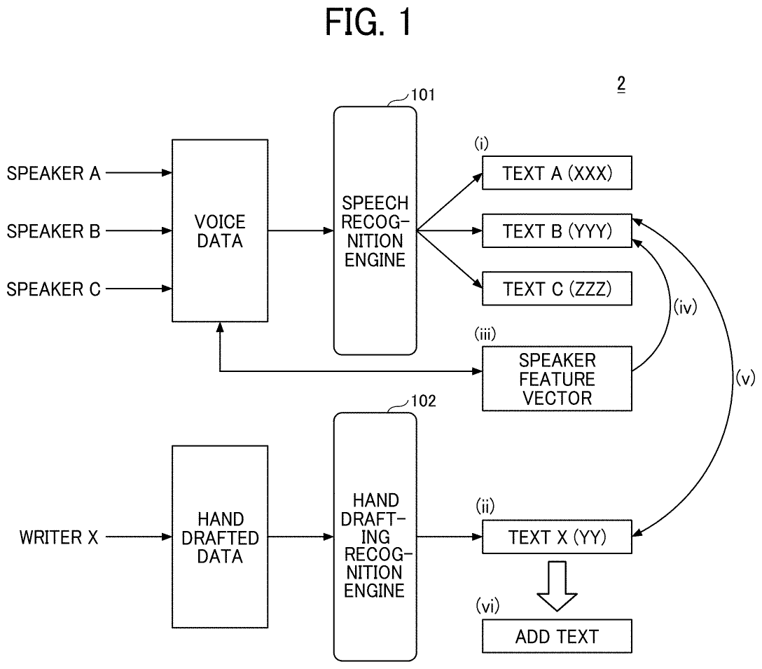

FIG. 1 is a diagram illustrating an overview of an operation performed by a display apparatus 2 of displaying text data obtained by performing speech recognition on a speech by a speaker.

(i) Speakers A, B, and C are speaking. A speech recognition engine 101 of the display apparatus 2 converts each speaker's speech into text data using a speech recognition technology. Text data A is text data converted from a speech by the speaker A. Text data B is text data converted from a speech by the speaker B. Text data C is text data converted from a speech by the speaker C. In the present embodiment, it is assumed that the speakers A, B, and C do not speak at the same time. However, this is merely one example, and in another example, the speaker A, B, and C may speak at the same or substantially the same time. In this case, the display apparatus 2 separates voice data of multiple speakers to voice data of each speaker.

(ii) In one example, a writer X is any one of the speakers A, B, and C. In another example, the writer X is a person other than the speakers A, B, and C. A hand drafting recognition engine 102 converts hand drafted data input by the writer X into text data X using a handwriting recognition technology.

(iii) The display apparatus 2 compares a speaker feature vector (an example of collation information) detected from the voice data of each of the writer X and the speakers A, B, and C with a speaker feature vector registered in advance, to determine whether a speaker feature vector is registered that has a degree of similarity equal to or greater than a threshold value.

(iv) In a case that the writer X is speaking, the speaker feature vector registered by the writer X is identified, and a user identifier (ID) of the writer X is also identified. In the following, a description is given of an example in which the writer X is speaking and the user ID of the speaker B is identified. In other words, the writer X and the speaker B is the same person.

(v) The display apparatus 2 determines whether the text data X converted from the hand drafted data input by the writer X and the text data B which is obtained by performing speech recognition on the voice data of the speaker B match each other at least in part.

(vi) When the text data X and the text data B match each other at least in part, the display apparatus 2 thereafter uses text data converted from the voice data of the speaker B (i.e., the writer X) for input assistance.

As described above, the display apparatus 2 identifies the writer with the voice data, and uses the voice data of the writer for input assistance when the text data X converted from the hand drafted data input by the writer X and the text data B obtained by performing speech recognition on the voice data of the writer X match each other at least in part. With this configuration, even if a person other than the writer speaks, the display apparatus 2 is prevented from displaying text data converted from voice data of the person other than the writer.

Further, since the text data converted from the voice is displayed next to the text data X drafted by the writer by an input device, the writer does not have to designate the display position. In addition, since the display apparatus 2 displays the text data converted from the voice in the same size as the text data X converted from the hand drafted data input by the writer, the writer does not have to designate the size of the character in advance (before the speaker speaks).

Terms:

The term “input device” refers to any devices or means with which a user hand drafted input is performable by designating coordinates on a touch panel. Examples or the input device include, but are not limited to, an electronic pen, a human finger, a human hand, and a bar-shaped member.

A series of user operations including engaging a writing/drawing mode, recording movement of an input device or a finger, and then disengaging the writing/drawing mode is referred to as a stroke. The engaging of the writing/drawing mode may include, if desired, pressing an input device against a display or screen, and disengaging the writing mode may include releasing the input device from the display or screen. Alternatively, a stroke includes tracking movement of the finger without contacting a display or screen. In this case, the writing/drawing mode may be engaged or turned on by a gesture of a user, pressing a button by a hand or a foot of the user, or otherwise turning on the writing/drawing mode, for example using a pointing device such as a mouse. The disengaging of the writing/drawing mode can be accomplished by the same or different gesture used to engage the writing/drawing mode, releasing the button, or otherwise turning off the writing/drawing mode, for example using the pointing device or mouse. The term “stroke data” refers to data based on a trajectory of coordinates of a stroke input with the input device, and the coordinates may be interpolated appropriately. Such stroke data may be interpolated appropriately. The term “hand drafted data” refers to data having one or more stroke data. In the present disclosure, a “hand drafted input” relates to a user input such as handwriting, drawing, and other forms of input. The hand drafted input may be performed via touch interface, with a tactile object such as a pen or stylus or with the finger. The hand drafted input may also be performed via other types of input, such as gesture-based input, hand motion tracking input or other touch-free input by a user.

The term “object” refers to an item displayed on a screen. The term “object” in this specification also represents an object of display. Examples of “object” include items displayed based on stroke data, objects obtained by handwriting recognition from stroke data, graphics, images, and characters.

A character string obtained by handwritten text recognition and conversion may include, in addition to text data, data displayed based on a user operation, such as a stamp of a given character or mark such as “complete,” a figure such as a circle or a star, or a straight line.

The term “text data” refers to one or more characters processed by a computer. The text data actually is one or more character codes. The text data include numbers, alphabets, and symbols, for example.

The term “conversion” refers to converting hand drafted data or voice data into one or more character codes and displaying a character string represented by the character codes in a predetermined font. The conversion includes conversion of hand drafted data into a figure such as a straight line, a curve, a square, or a table.

### Example of Hardware Configuration

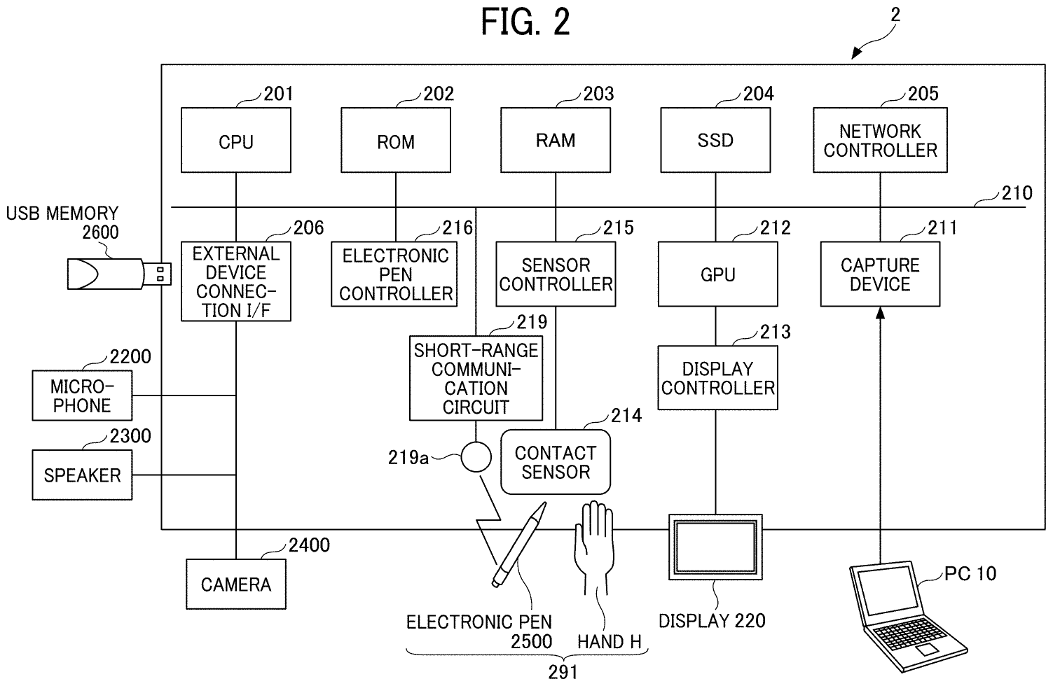

FIG. 2 is a block diagram illustrating an example of a hardware configuration of the display apparatus 2 according to the present embodiment. The display apparatus 2 of the present embodiment includes a central processing unit (CPU) 201, a read only memory (ROM) 202, a random access memory (RAM) 203, a solid state drive (SSD) 204, a network controller 205, and an external device connection interface (I/F) 206. The display apparatus 2 is a shared terminal that a plurality of users can use for sharing information.

The CPU 201 controls overall operation of the display apparatus 2. The ROM 202 stores a control program such as an initial program loader (IPL) to boot the CPU 201. The RAM 203 is used as a work area for the CPU 201.

The SSD 204 stores various data such as an operating system (OS) and a program for the display apparatus 2. This program may be an application program that runs on an information processing apparatus installed with a general-purpose operating system (OS) such as Windows®, Mac OS®, Android®, and iOS®. In other words, the display apparatus 2 may be a personal computer (PC) or a smartphone, for example.

The network controller 205 controls communication with an external device through a network. The external device connection IT 206 controls communication with a universal serial bus (USB) memory 2600 and other external devices including a camera 2400, a speaker 2300, and a microphone 2200, for example.

The display apparatus 2 further includes a capture device 211, a graphics processing unit (GPU) 212, a display controller 213, a contact sensor 214, a sensor controller 215, an electronic pen controller 216, a short-range communication circuit 219, and an antenna 219a for the short-range communication circuit 219.

The capture device 211 transfers still image data or moving image data input from a PC 10 to the GPU 212. The GPU 212 is a semiconductor chip dedicated to processing of a graphical image. The display controller 213 controls display of an image processed by the GPU 212 for output through a display 220, for example.

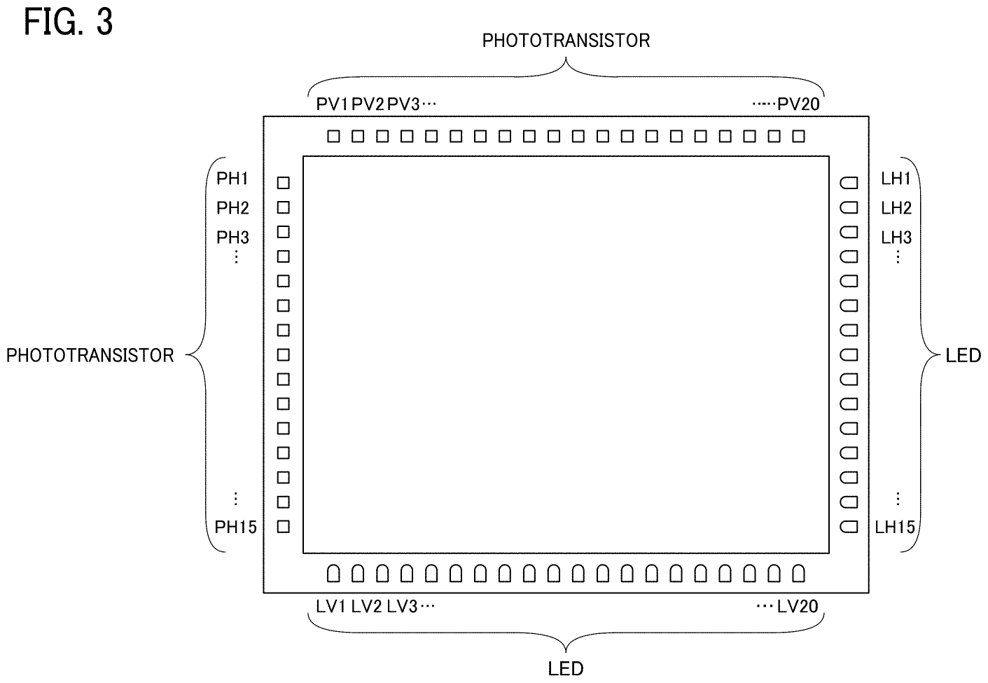

FIG. 3 illustrates a hardware configuration of the contact sensor 214. In this figure, infrared light emitting LEDs and phototransistors in one row are arranged at equal intervals, and the infrared light emitting LEDs and the phototransistor are arranged in a manner that they face each other. The figure illustrates an example in which twenty infrared light emitting LEDs and twenty phototransistors are arranged in the horizontal direction and fifteen infrared light emitting LEDs and fifteen phototransistors are arranged in the vertical direction. However, more LEDs and phototransistors are actually to be arranged in a case that the size of the contact sensor is equal to or larger than 40 inches.

The contact sensor 214 outputs, to the sensor controller 215, the number of a particular phototransistor at which the light is blocked by an object, in other words, the particular phototransistor that does not sense the light. Based on the number of the particular phototransistor, the sensor controller 215 detects a particular coordinate that is touched by the object. The electronic pen controller 216 communicates with the electronic pen 2500 to detect contact by the tip or bottom of the electronic pen with the display 220. The short-range communication circuit 219 is a communication circuit in compliance with a near field communication (NFC) or Bluetooth®, for example.

The electronic whiteboard 200 further includes a bus line 210. Examples of the bus line 210 include an address bus and a data bus, which electrically connect the components including the CPU 201, one another.

The contact sensor 214 is not limited to the infrared blocking system type, and may be a different type of detector, such as a capacitance touch panel that identifies the contact position by detecting a change in capacitance, a resistance film touch panel that identifies the contact position by detecting a change in voltage of two opposed resistance films, or an electromagnetic induction touch panel that identifies the contact position by detecting electromagnetic induction caused by contact of an object to a display. In addition to or in alternative to detecting a touch by the tip or bottom of the electronic pen 2500, the electronic pen controller 216 may also detect a touch by another part of the electronic pen 2500, such as a part held by a hand of the user.

Functions:

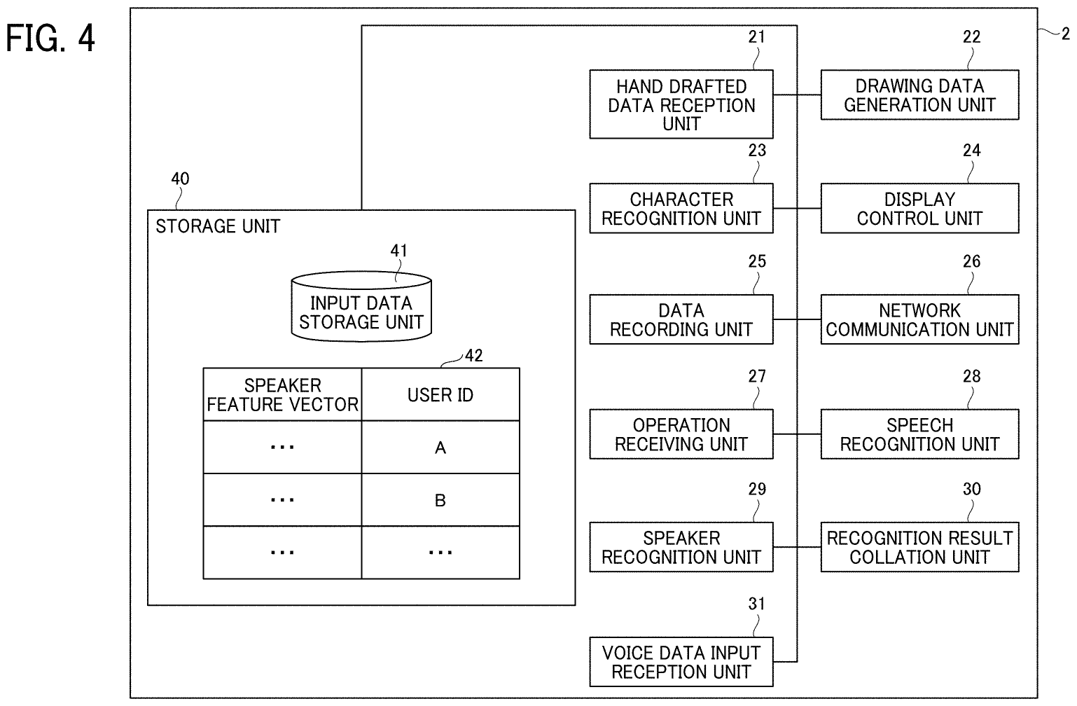

Referring to FIG. 4, a functional configuration of the display apparatus 2 is described according to the present embodiment. FIG. 4 is a block diagram illustrating an example of the functional configuration of the display apparatus 2 according to the present embodiment. The display apparatus 2 includes a hand drafted data reception unit 21, a drawing data generation unit 22, a character recognition unit 23, a display control unit 24, a data recording unit 25, a network communication unit 26, an operation receiving unit 27, a speech recognition unit 28, a speaker recognition unit 29, a recognition result collation unit 30, a voice data input reception unit 31, and a storage unit 40. These functional units of the display apparatus 2 are implemented by operation of any of the hardware components illustrated in FIG. 2 in corporation with instructions from the CPU 201 according to the program expanded from the SSD 204 to the RAM 203. Alternatively, these functional units of the display apparatus 2 are caused to function by operation of any of the hardware components illustrated in FIG. 2 in corporation with instructions from the CPU 201 according to the program expanded from the SSD 204 to the RAM 203.

The hand drafted data reception unit 21 detects coordinates of a position where the electronic pen 2500 touches with respect to the contact sensor 214. The drawing data generation unit 22 acquires the coordinates of the position touched by the pen tip of the electronic pen 2500 from the hand drafted data reception unit 21. The drawing data generation unit 22 interpolates a plurality of contact coordinates into a coordinate point sequence, to generate stroke data.

The character recognition unit 23 performs character recognition processing on one or more stroke data (hand drafted data) input by the writer and converts the stroke data into one or more character codes. The character recognition unit 23 recognizes characters (of multilingual languages such as English as well as Japanese), numbers, symbols (e.g., %, $, and &), graphics (e.g., lines, circles, and triangles) concurrently with a pen operation by the writer. Although various algorithms have been proposed for the recognition method, a detailed description is omitted on the assumption that known techniques can be used in the present embodiment.

The display control unit 24 displays, on the display 220, hand drafted object, text data string converted from the hand drafted data, and an operation menu to be operated by the writer. The data recording unit 25 stores, for example, hand drafted data that is input on the display apparatus 2, text data converted from the hand drafted data, screen data that is input from the PC, and files in the storage unit 40. The network communication unit 26 connects to a network such as a local area network (LAN), and transmits and receives data to and from other devices via the network.

The voice data input reception unit 31 encodes voice data input from the microphone 2200 by pulse code modulation (PCM). The voice data that is input from the microphone 2200 and encoded by PCM is temporarily stored in the RAM 203 and used by the speech recognition unit 28 and the speaker recognition unit 29.

The speaker recognition unit 29 extracts acoustic features (an example of feature information) from the voice data input from the microphone 2200 and encoded by PCM at short time intervals such as several tens of milliseconds. Further, the speaker recognition unit 29 converts the value of the acoustic features into an acoustic feature vector in which the value is represented by a vector. The speaker recognition unit 29 calculates a speaker feature vector from the acoustic feature vector using a universal background model (UBM) model or a speaker feature extraction model. Further, the speaker recognition unit 29 compares the plurality of speaker feature vectors with speaker feature vectors (registered speaker feature vectors), each of which is in advance for each user in the storage unit 40, to obtain a degree of similarity. Based on the determination that the degree of similarity is, for example, 60% or more, the speaker corresponding to the voice data is identified as a registered speaker.

Each conference participant speaks for 10 seconds or more before a conference by using a PC, a smartphone, or the like, and transmits a file of voice data (data encoded by PCM) and a user ID to the display apparatus 2 via a network. The user ID may be a character code of kanji or hiragana (e.g., Shift Japanese Industrial Standards (JIS)). The PC or the smartphone uses, for example, the hypertext transfer protocol (HTTP) as a protocol for the transmission. In response to receiving voice data of each conference participant, the speaker recognition unit 29 of the display apparatus 2 extracts acoustic features for every short time such as several tens of milliseconds for the voice data, and calculates an acoustic feature vector, which is obtained by expressing the value of the acoustic features in the form of vector. The speaker recognition unit 29 calculates the speaker feature vector from the acoustic feature vector using a UBM model or a speaker feature extraction model. The speaker recognition unit 29 stores, in the storage unit 40, a plurality of speaker feature vectors as user information 42 in association with the received user IDs.

For the voice data that is input from the microphone 2200 and encoded by PCM, the speech recognition unit 28 extracts a feature amount of voice, identifies a phoneme model, and identifies a word using a pronunciation dictionary, to output text data of the identified word. Pronunciation dictionary data is stored in advance in the SSD 204. Any other suitable method may be used as the speech recognition method. For example, a speech recognition method using a recurrent neural network (RNN) is known.

The recognition result collation unit 30 compares the text data generated by the character recognition performed by the character recognition unit 23 on the hand drafted data with the text data generated by speech recognition performed by the speech recognition unit 28, to determine whether both text data match each other at least in part.

The display apparatus 2 includes the storage unit 40 implemented by, for example, the SSD 204 or the RAM 203 illustrated in FIG. 2. In the storage unit 40, an input data storage unit 41 is constructed. Further, in the storage unit 40, user information 42 is stored at the start of a conference or before the start of a conference. The user information 42 associates, for each user (e.g., a participant in the conference), the speaker feature vector with the user ID.

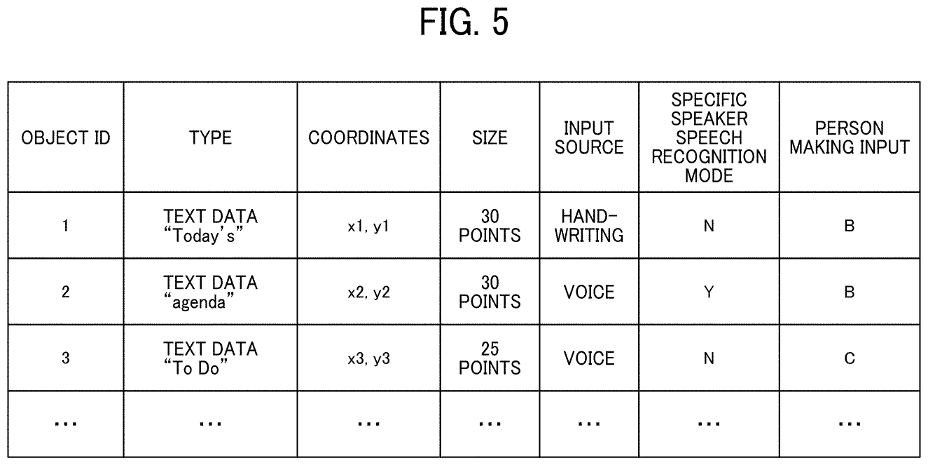

FIG. 5 illustrates an example of input data stored in the input data storage unit 41. The input data storage unit 41 stores an object that is input. Items that the input data storage unit 41 includes is described in the following.
An “object ID” is identification information of an object to be displayed by the display apparatus 2.
A “type” indicates a type of the object. Examples of the type include, but are not limited to, text data, stroke data, an image, a file, and a table. Regarding text data obtained by character recognition, text data converted by character recognition in one conversion unit is regarded as one object. Regarding text data obtained by speech recognition, text data converted by speech recognition in one conversion unit is regarded as one object. For example, voice data is divided to multiple units between which a silent state of equal to or longer than a certain time period is present. Regarding stroke data, a stroke that is input from the time the writer starts inputting until there is no input for a certain time period is regarded as one object.
“Coordinates” indicate a display position of the object on the display 220. These coordinates may be, for example, a position of an upper left vertex in a circumscribed rectangle of the object.

A “size” indicates a size of the object. A size of text data is defined by a size of one character. A size of stroke data is defied by a height of a circumscribed rectangle of one entire object.
An “input source” indicates a source from which the object is input. For example, the source of the text data includes hand drafted input, voice input, and file input.
A “specific speaker speech recognition mode” is an input mode in which text data obtained by speech recognition is continuously input to text data obtained by performing character recognition on hand drafted data. In the example of FIG. 5, a value of the specific speaker speech recognition mode associated with an object identified by the object ID “2” is “Y”. This indicates that the object identified by the object ID “2” is input in the specific speaker speech recognition mode.

A “person making input” is identification information of a person who has input the object. For text data obtained by character recognition on hand drafted data, the person making input is determined based on a collation result of the speaker feature vector of voice data on which speech recognition is performed immediately after the recognition of hand drafted data is performed. For text data obtained by speech recognition, the person making input is determined based the collation result of the speaker feature vector generated from voice data.

Screen Example of Text Data Input:

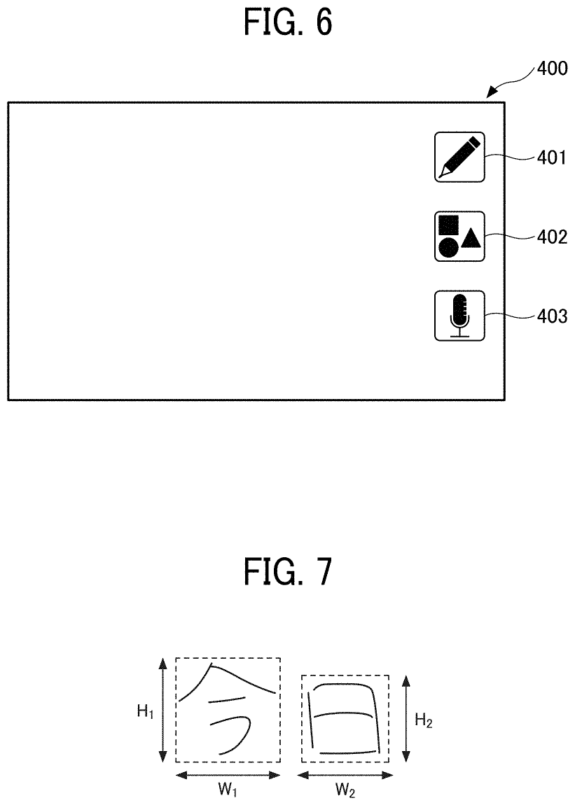

Referring to FIG. 6, a screen operated by a writer who input data by voice is described. FIG. 6 illustrates an example of an initial screen 400 displayed by the display apparatus 2. The initial screen 400 is a screen displayed immediately after the display apparatus 2 is turned on or immediately after a login. The initial screen 400 displays a hand drafting input icon 401 for setting an operation mode to a hand drafting input mode, a figure drawing icon 402 for setting an operation mode to a figure drawing mode, and a voice input transition icon 403 for setting an operation mode to a voice input mode in which text data as recognition results of character recognition and speech recognition are collated to input text data.

A writer (e.g., a chairperson) selects the hand drafting input icon 401 and the voice input transition icon 403, writes, for example, “Today” in a desired position on the screen, and utters “today” after the hand drafting. The hand drafting and the speaking may be performed substantially at the same time (concurrently). The character recognition unit 23 searches dictionary data using the hand drafted data (word) of “Today” as a search key. Based on determination that the dictionary data includes a character string (word) corresponding the search key, the character recognition unit 23 outputs a character string of “Today” as text data.

The hand drafted input and voice input may be performed in languages other than English, such as in Japanese. FIG. 7 illustrates an example in which the writer inputs hand drafted Japanese characters “ [symbol] ” meaning “today”. As illustrated in FIG. 7, the character recognition unit 23 determines a size of the hand drafted data and outputs a font size in addition to the text data. FIG. 7 is a diagram illustrating how the character recognition unit 23 calculates the font size according to the present embodiment. A character recognition unit 23 identifies a boundary between characters based on, for example, a distance between strokes to divide an object of stroke data to characters. The character recognition unit 23 obtains the font size based on the average of widths W1 and W2 and the average of the heights H1 and H2 of the two characters. In another example, the character recognition unit 23 adopt a size of the largest character or the smallest character of the two characters as the font size. The font size of alphabets, alphanumeric characters, and the like may be obtained in the same in substantially the same manner.

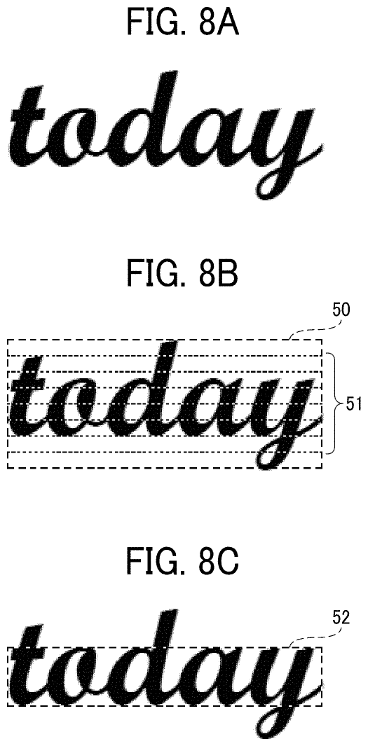

FIG. 8A to FIG. 8C are diagrams illustrating how to calculate a font size of cursive or print. In the English cursive illustrated in FIG. 8A, the character recognition unit 23 may have difficulties in identifying a boundary between characters based on a distance between strokes. In view of such an issue, in a case where that no start (pen-down) of the next hand drafted input is detected even when a predetermined time period elapses after the user starts (pens down) and ends (pens up) a hand drafted input of a character, the character recognition unit 23 obtains a font size for the hand drafted data from the pen-down to the pen-up. When the next hand drafted input (pen-down) is performed within the predetermined time period after the hand drafted input is ended (pen-up), it is considered that the hand drafted input is being performed. The term “pen-up” refers to a change from a state in which the contact sensor 214 detects that light is being blocked to a state in which the contact sensor detects that light is no more blocked. The term “pen-down” refers to a change from a state in which the contact sensor 214 detects no blocking of light to a state in which the contact sensor detect that the light is blocked. The elapse of the predetermined time period is checked so that a horizontal bar of “t” and superscript dots of “i” or “j” is not regarded as one character or a character string.

When the user writes “today” in cursive as illustrated in FIG. 8A, a pen-up and a pen-down occur between the start (pen-down) of writing of “t” and the end (pen-up) of writing of “y”. However, a time period from the pen-up to the pen-down is shorter than the predetermined time period, the character recognition unit 23 obtains a font size from the entire character string “today”.

Next, as illustrated in FIG. 8B, the character recognition unit 23 obtains a rectangle 50 circumscribing the character string “today”.

Next, the character recognition unit 23 sets lines 51 that horizontally slice the rectangle 50 at regular intervals, and obtains the number of pixels of “today” on the lines 51. The character recognition unit 23 predicts an area in which the number of pixels on the lines 51 is large as a font size. In the embodiments, the pixel is a display pixel of the display 220. The regular intervals are set in units of pixels or in units of lengths, for example. In FIG. 8B, the intervals between the lines 51 are large in order to simplify the drawing. An example is described in which each of the lines 51 is set for each pixel.

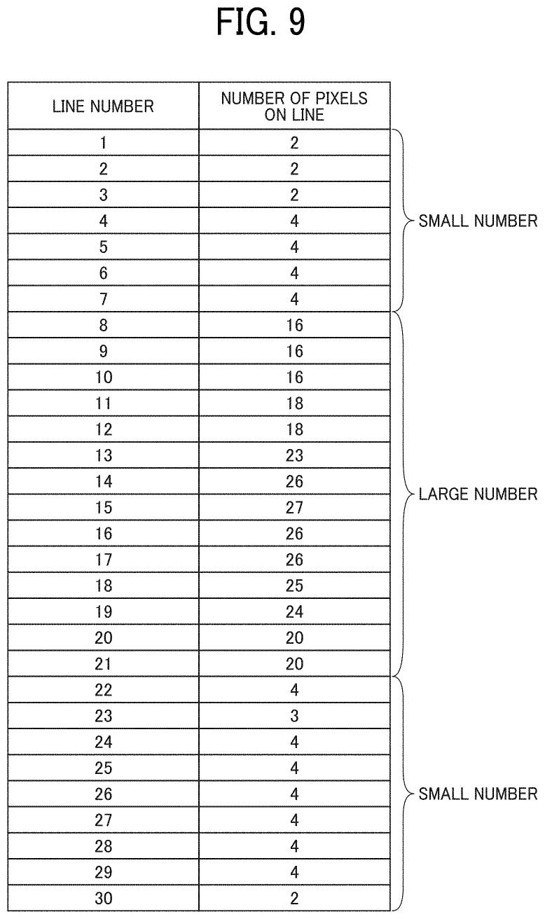

FIG. 9 is a table indicating, for each of the lines 51, the number of pixels of “today” on the lines 51 that horizontally slice the rectangle. In FIG. 9, it is assumed that the number of pixels in the vertical direction of the rectangle is 30 pixels. Accordingly, the table of FIG. 9 has 30 lines from the first line (upper side of the rectangle 50) to the 30th line (lower side of the rectangle 50).

In FIG. 9, the lines are roughly classified into lines having a large number of pixels (8th to 21st lines) and lines having a small number of pixels (1st to 7th lines and 22nd to 30th lines). The character recognition unit 23 determines the font size based on the number of pixels on the lines 51. In the example of FIG. 9, the character recognition unit 23 regards the number of lines from the 8th line to 21st line as the size of the character in the height direction, to determine the font size. The character recognition unit 23 regards that the horizontal size of the character is the same as the vertical size of the character.

A boundary line (8th and 22nd lines, in this example) is determined by using clustering, for example. Clustering is one form of machine learning, which groups data based on the similarity between the data. In the example of FIG. 9, using the number of pixels as a feature, data is grouped into two groups, i.e., a group in the number of pixels is equal to or less than four and a group in which the number of pixels is more than four. Examples of the clustering include the k-means method, the group average method, Ward's method, minimum distance method, and maximum distance method. Although the number of pixels per line does comply with a normal distribution, an appropriate boundary is determined in the above-described manner.

Referring to FIG. 8C, FIG. 8C illustrates a size frame 52 in which the number of lines from the 8th line to the 21st line is regarded as the size of the character in the height direction of the characters. Thus, the character recognition unit 23 determines the font size of the hand drafted data of cursive. Since the size frame 52 has a slightly smaller font size, the character recognition unit 23 may regard the size frame 52 as having a slightly larger size or determine the font size as being slightly larger than the font size determined by the size frame 52.

Although the description given above referring to FIG. 8A to FIG. 8C is an example in which the font size of cursive is determined, the font size of print (also referred to as block letters) can be determined in the same or in substantially the same manner. The print refers to a typeface in which each character is independent.

The character recognition unit 23 determines whether the character recognition unit determines the font size in the manner as described referring to FIG. 7 or in the manner as described referring to FIG. 8A to FIG. 8C based on language information, in a case that the user sets the language of a hand drafted input (the language of text into which the hand drafted input to be converted). In a case that the language is not set, the character recognition unit 23 may automatically determine the language. For example, the character recognition unit 23 may convert text into several languages and automatically determine a particular language having the highest accuracy as the language of the text into which the hand drafted input is to be converted. In another example, the character recognition unit 23 may automatically determine the language based on a correspondence model that is generated by performing machine learning of the correspondence between stroke data and languages.

Referring again to FIG. 6, the CPU 201 converts the character string “Today” into font data of the specified font size, and issues an instruction to display the font data at a position where the character string “Today” is hand drafted. The display control unit 24 controls the display to display the font data (an example of first text data) according to the instruction. The display control unit 24 erases “Today” (hand drafted data) drawn by hand drafting and then displays the font data of “Today”.

On the other hand, the speech recognition unit 28 performs extraction of a feature amount of voice, identification of a phoneme model, and identification of a word using a pronunciation dictionary on voice (voice data encoded by PCM) of “today” that is input from the microphone 2200, to output text data of the identified word “today” (an example of second text data). The voice (voice data encoded by PCM) of “today” is an example of first voice data.

Further, for the voice data “today”, the speaker recognition unit 29 extracts acoustic features for every short time such as several tens of milliseconds, and converts the extracted features to a feature acoustic feature vector, which is obtained by expressing the value by a vector. The speaker recognition unit 29 calculates a speaker feature vector from the acoustic feature vector using a UBM model or a speaker feature extraction model. Further, the speaker recognition unit 29 compares the calculated speaker feature vector with each of speaker feature vectors of speakers registered in advance in the user information 42 to obtain a degree of similarity. When the comparison result indicates that a particular speaker feature vector whose degree of similarity with the calculated speaker feature vector is equal to or greater than a threshold value (e.g., 60% or greater) is registered in the user information 42, the speaker recognition unit 29 determines that a person identified by a user ID associated with the particular speaker feature vector is a writer (e.g., a chairperson). The data recording unit 25 stores the user ID of the speaker in the RAM 203 in association with the text data “today”.

Subsequently, the recognition result collation unit 30 compares the text data obtained by conversion by the character recognition unit 23 with the text data obtained by conversion by the speech recognition unit 28. When the comparison result indicates that both text data match each other at least in part, the recognition result collation unit 30 determines that an operation mode is to be set to the specific speaker speech recognition mode. In the specific speaker speech recognition mode, the display control unit 24 displays a voice input mark 404 to the right of the character string “Today”.

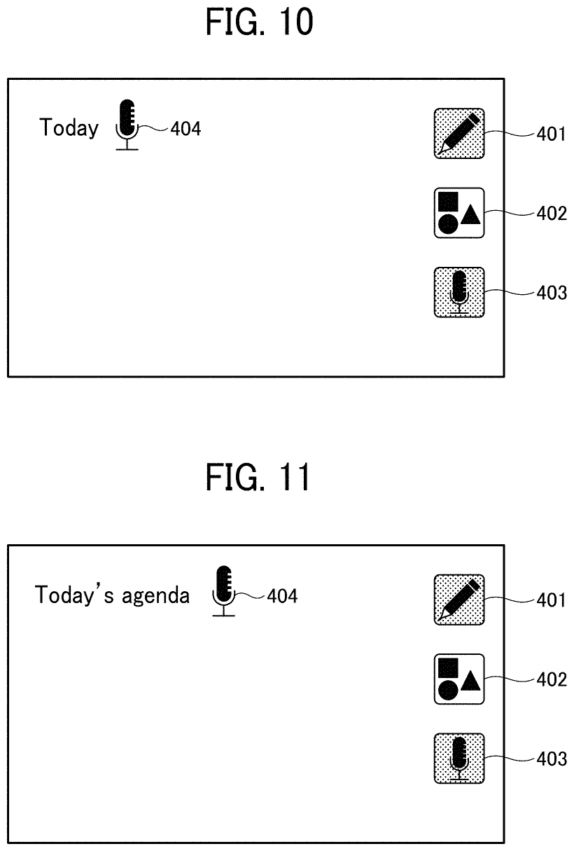

FIG. 10 illustrates an example of the voice input mark 404. The voice input mark 404 is displayed to the right of “Today” displayed as text data. In other words, the voice input mark 404 is displayed next to the end of text data in the input direction of characters. The voice input mark 404 indicates that the matching of the voice of the writer is completed, and text data obtained by recognizing the writer's voice is to be displayed from the position where the voice input mark is displayed.

Subsequently, when the writer (e.g., a chairperson) speak “'s agenda”, the speech recognition unit 28 performs, on voice (voice data encoded by PCM) “'s agenda” that is input from the microphone 2200, extraction of features of the voice, identification of a phoneme model, identification of a word using a pronunciation dictionary, to output text data “'s agenda”. The voice (voice data encoded by PCM) “'s agenda” is an example of second voice data, which is input after the input of the first voice data.

Further, for the voice data “'s agenda”, the speaker recognition unit 29 extracts acoustic features for every short time such as several tens of milliseconds, and generates an acoustic feature vector, which is obtained by expressing the value by a vector. The speaker recognition unit 29 calculates a speaker feature vector from the acoustic feature vector using a UBM or a speaker feature extraction model. Further, the speaker recognition unit 29 compares the calculated speaker feature vector with each of speaker feature vectors of speakers stored in advance in the user information 42 to obtain a degree of similarity. When the speaker recognition unit 29 determines that the degree of similarity with the speaker feature vector of the writer who writes “Today” is equal to or greater than a threshold value (e.g., equal to or greater than 60%), the speaker recognition unit 29 outputs information indicating that the speaker who speaks “'s agenda” is the same person as the writer (the same person who speaks “today”).

When the CPU 201 determines that the speaker is the chairperson (the same speaker who speaks “today”), the display control unit 24 controls the display to display “'s agenda” whose font size is same as that of “Today” to the right of the character string “Today”, and display the voice input mark 404 to the right of the “'s agenda” (an example of third text data).

FIG. 11 illustrates an example of the voice input mark 404 moved to the right of “Today's agenda”. Thus, the voice input mark 404 is moved to the right of the text data input by speech recognition.

When a person who is different from the writer speaks, the speaker recognition unit 29 calculates a speaker feature vector based on voice data input from the microphone 2200 in substantially the same manner as described above. Further, the speaker recognition unit 29 compares the calculated speaker feature vector with each of speaker feature vectors of speakers registered in advance to obtain a degree of similarity. When the speaker recognition unit 29 determines that the degree of similarity between the calculated speaker feature vector and the speaker feature vector of a speaker other than the writer is equal to or greater than a threshold value (e.g., 60%), the speaker recognition unit 29 outputs information indicating that the voice is not uttered by the writer (the same speaker who speaks “today”).

The speech recognition unit 28 performs, on the voice (voice data encoded by PCM) of a person other than the writer input from the microphone 2200, extraction of a feature amount of voice, identification of a phoneme model, and identification of a word using a pronunciation dictionary, to output converted text data. When the speaker of “'s agenda” is not the same person as the speaker of “today”, it means the speaker of “'s agenda” is not the chairperson. Accordingly, the CPU 201 does not display the converted text data. Alternatively, the converted text data may be displayed in a fixed position such as the right end of the display 220. However, the converted text data is not displayed next to the text data (“today”) obtained by performing character recognition on the hand drafted data.

Processing Procedure by Display Apparatus:

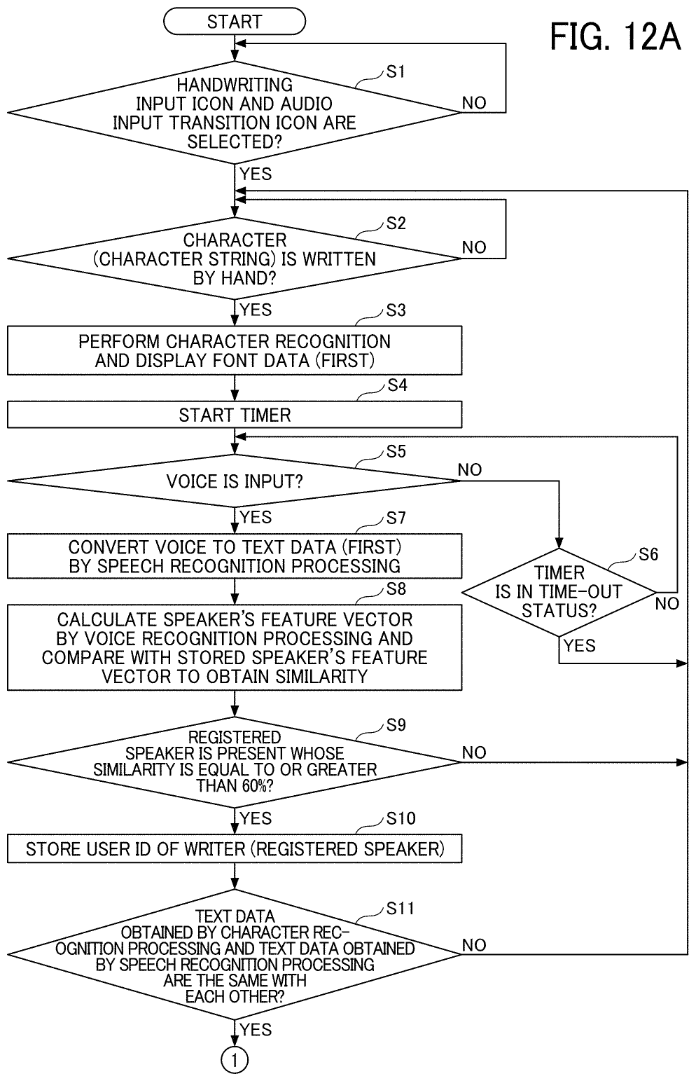

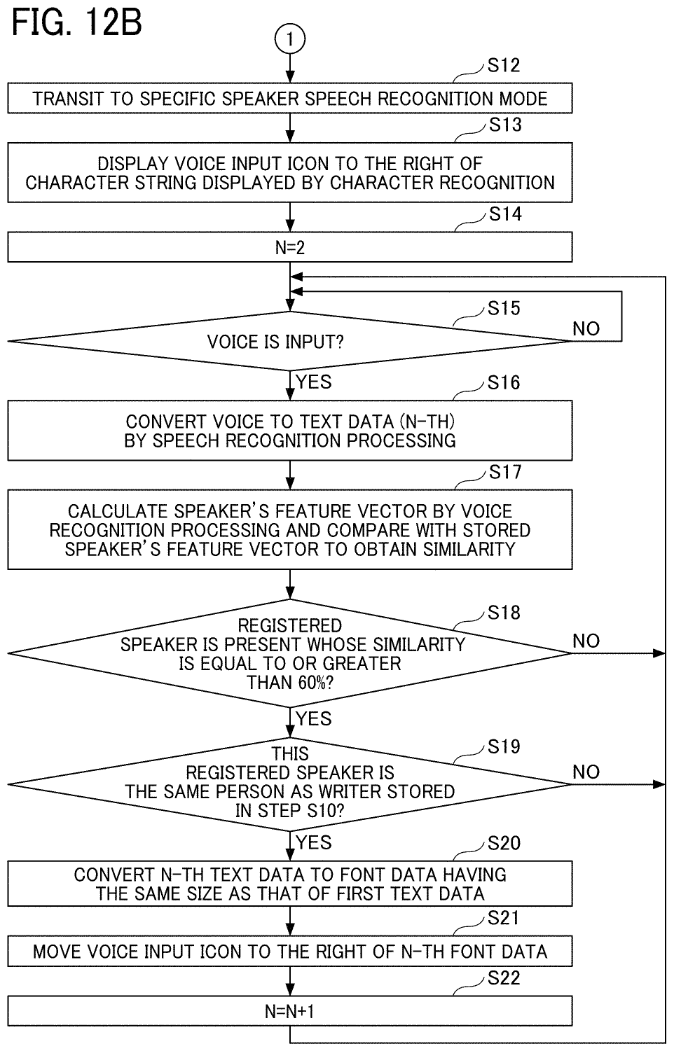

FIG. 12A and FIG. 12B are flowcharts illustrating an operation performed by the display apparatus 2 of receiving input of text data obtained by performing character recognition on hand drafted data and text data obtained by performing speech recognition on voice data. The operation of FIG. 12A and FIG. 12B starts from the state of the initial screen 400, for example.

The operation receiving unit 27 detects that the hand drafting input icon 401 and the voice input transition icon 403 are selected (S1).

Next, the character recognition unit 23 determines whether a character is written by the input device such as a user's hand (S2).

Based on the determination that a character is inputted (YES in S2), the character recognition unit 23 recognizes the input character and converts the input character into text data. The display control unit 24 displays the text data (S3). The character recognition unit 23 automatically performs character recognition when a certain time period has elapsed since the writer released the input device from the touch panel (since a pen-up). In another example, the character recognition unit 23 performs character recognition in response to an operation by the writer. Further, as illustrated in FIG. 7, the character recognition unit 23 determines a size of the character, to determine a size of text data.

The speech recognition unit 28 starts a timer that measures a time period from when the text data converted from the hand drafted input by the writer is displayed (S4).

Then, the speech recognition unit 28 monitors voice data detected by the microphone 2200, to determine whether voice is input (S5).

When the speech recognition unit 28 determines that the timer times out without detecting voice input (Yes in S6), the operation returns to step S2. The timer times out when a certain time period elapses since the text data converted from the hand drafted input is displayed. The certain time period is set in advance, for example, by a user or a designer of the display apparatus 2. When the speech recognition unit 28 determines that the timer times out without detecting voice input (No in S6), the operation returns to step S5.

When voice is input before the timer times out (Yes in S5), the speech recognition unit 28 converts the voice that is input into text data by speech recognition processing (S7). In the following description, this text data may be referred to as “first converted text data”, in order to simplify the description.

In addition, the speaker recognition unit 29 calculates a speaker feature vector of the speaker by speaker recognition processing, and compares the calculated speaker feature vector with a speaker feature vector of each of speakers stored in the user information 42, to obtain a degree of similarity (S8).

The speaker recognition unit 29 determines whether a speaker feature vector is stored whose degree of similarity is equal to or greater than a threshold value (e.g., equal to or greater than 60%) (S9). In a case that multiple participants participating in the conference speak non-concurrently, the degree of similarity is calculated between the speaker feature vector calculated by the speaker recognition processing and voice data of a speech that is uttered first after the timer starts. This is because the writer often speaks first. Even in a case that multiple participants participating in the conference speak concurrently, it is considered that the degree of similarity with the voice data of the writer is calculated by using voice data corresponding a certain time period from the start of the voice data for the comparison. Even in a case that a speaker feature vector of a participant who is different from the writer is compared with the speaker feature vector stored in the storage unit 40 and the degree of similarity is equal to or greater than the threshold value, text data obtained by character recognition processing often does not match text data obtained by speech recognition processing. Accordingly, for such the speaker feature vector of the participant different from the speaker, a result of determination in step S11 described below is No.

When the speaker recognition unit 29 determines that a speaker feature vector is stored whose degree of similarity is equal to or greater than the threshold value (e.g., equal to or greater than 60%) (Yes in S9), the speaker recognition unit 29 stores a particular user ID that is stored in the user information 42 in association with the speaker feature vector whose degree of similarity is equal to or greater than the threshold value (e.g., equal to or greater than 60%) as the inputter of the input data in the input data storage unit 41 (S10). In other words, the identification information of the writer is stored.

Next, the recognition result collation unit 30 determines whether the text data obtained by the character recognition processing and the text data (the first converted text data) obtained by performing speech recognition on the voice data used when identified as the writer match each other at least in part (S11). This determination is performed by, for example, determining whether a part of the text data obtained by the character recognition processing is included in the text data obtained by the speech recognition processing, or determining whether a part of the text data obtained by the speech recognition processing is included in the text data obtained by the character recognition processing.

When the text data obtained by the character recognition processing and the text data obtained by the speech recognition processing do not match each other at least in part (No in S11), this means that the writer and speaker are different. Accordingly, the operation returns to step S2.

When the text data obtained by the character recognition processing and the text data obtained by the speech recognition processing match each other at least in part (Yes in S11), the speech recognition unit 28 transitions to the specific speaker speech recognition mode (S12).

In the specific speaker speech recognition mode, the display control unit 24 displays the voice input mark 404 to the right of the text data displayed by character recognition (513). Thus, the writer can recognize that the voice input is available.

Next, the speech recognition unit 28 sets a variable N to “2” (S14). The variable N is an identification number of text data on which speech recognition is to be performed.

In response to an input of voice (Yes in S15), the speech recognition unit 28 converts the voice into the N-th text data by speech recognition processing (S16).

Next, the speaker recognition unit 29 calculates a speaker feature vector of the speaker by speaker recognition processing, and compares the calculated speaker feature vector with a speaker feature vector of each of speakers stored in the user information 42, to obtain a degree of similarity (S17).

The speaker recognition unit 29 determines whether a speaker feature vector is stored whose degree of similarity is equal to or greater than a threshold value (e.g., equal to or greater than 60%) (S18).

When a speaker feature vector is stored whose degree of similarity is equal to or greater than a threshold value (e.g., equal to or greater than 60%) (Yes in S18), the speaker recognition unit 29 determines whether this speaker is the same as the speaker identified in step S10 (S19). When the speakers are different, the text data obtained by the speech recognition processing is not to be displayed next to the text data displayed on the display. Accordingly, the operation returns to step S15.

When the speakers are the same (Yes in S19), the display control unit 24 converts the N-th text data into font data having the same size as the first converted text data obtained by performing character recognition on the hand drafted data, and displays the font data at the position of the voice input mark 404 (next to the (N−1)-th text data) (S20). The size of the N-th text data does not have to be exactly the same as the size of the first converted text data obtained by character recognition. In another example, the size of the N-th text data may be enlarged or reduced according to, for example, the volume of voice.

The display control unit 24 moves the voice input mark 404 to the right of the N-th text data (S21).

The CPU 201 increments the variable N by one, and the operation returns to step S15.

As described, the display apparatus 2 according to the present embodiment, in response to detecting the writer's speech before the timer times out after the input of text data obtained by performing character recognition on the hand drafted data, displays the text data obtained by speech recognition next to the text data obtained by performing character recognition on the hand drafted data.

Exit from Specific Speaker Speech Recognition Mode:

As illustrated in FIG. 10, in the specific speaker speech recognition mode, the voice input mark 404 is displayed to the right of text data. When the writer clicks the voice input mark 404, the operation receiving unit 27 receives this operation by the writer, and the character recognition unit 23 cancels the specific speaker speech recognition mode. The display control unit 24 erases the voice input mark 404 and resets the display of the voice input transition icon 403 to the initial state (e.g., for example, resets the highlighted display to the original display).

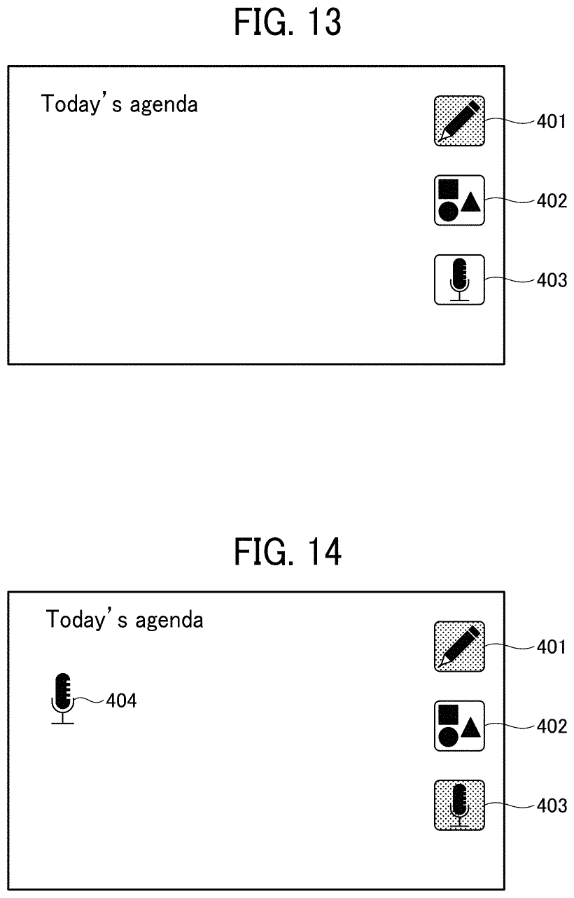

FIG. 13 illustrates an example of a screen in which the voice input mark 404 is erased. Since the hand drafting input icon 401 is kept turned on, the character recognition unit 23 can perform character recognition on hand drafted data input by the writer with the input device such as the writer's finger, and the display control unit 24 can display text data obtained by the character recognition.

In another example, the CPU 201 cancels the specific speaker speech recognition mode when the writer clicks the voice input mark 404 twice in succession (double clicks).

As described, the display apparatus 2 according to the present embodiment compares text data obtained by performing speech recognition on voice data with text data obtained by performing character recognition on hand drafted data, and the display apparatus 2 displays the text data obtained by performing speech recognition on voice data when the two text data match each other. Therefore, even when a person different from the writer speaks, the display apparatus 2 does not display text data corresponding to voice data of the person different from the writer.

Further, since the text data obtained by the speech recognition is displayed next to the text data obtained by performing character recognition on the hand drafted data, the writer does not have to designate a display position where the text data is to be displayed. Further, since the display apparatus 2 displays the text data obtained by speech recognition in the same size as the text data obtained by performing character recognition on the hand drafted data, the writer does not have to designate the size of the character in advance (before the speaker speaks).

### Second Embodiment

In the present embodiment, a description is given of the display apparatus 2 that in the specific speaker speech recognition mode, moves the voice input mark 404 in response to an operation by the writer and displays text data obtained by speech recognition at a position where the voice input mark 404 is moved. Aspects of the first embodiment and aspects of the second embodiment can be combined as appropriate.

On the screen illustrated in FIG. 10, a writer (e.g., a chairperson can move the voice input mark 404 to a desired position by dragging and dropping the voice input mark 404 with the input device (an operation of touching the voice input mark 404 with the input device, moving the voice input mark with the input device in contact with the display, and releasing the input device from the display.

FIG. 14 illustrates an example in which the voice input mark 404 is moved. In FIG. 14, the voice input mark 404 is moved below the characters “To” of “Today's”.

Subsequently, when the writer (e.g., a chairperson) speaks “parentheses one”, the speech recognition unit 28 performs, on voice (voice data encoded by PCM) “parentheses one” that is input from the microphone 2200, extraction of features of the voice, identification of a phoneme model, identification of a word using a pronunciation dictionary, to outputs text data “(1)”.

Further, for the voice data “parentheses one”, the speaker recognition unit 29 extracts acoustic features for every short time such as several tens of milliseconds, and generates an acoustic feature vector, which is obtained by expressing the value by a vector. The speaker recognition unit 29 calculates a speaker feature vector from the acoustic feature vector using a UBM model or a speaker feature extraction model.

Further, the speaker recognition unit 29 compares the calculated speaker feature vector with each of speaker feature vectors of speakers stored in advance in the user information 42 to obtain a degree of similarity. When the speaker recognition unit 29 determines that a speaker feature vector is stored whose degree of similarity is equal to or greater than a threshold value (e.g., equal to or greater than 60%) and that the speaker feature vector is a speaker feature vector of the writer, the speaker recognition unit 29 outputs information indicating that the speaker of “parentheses one” is the same person as the writer (the same person who speaker “today”).

When the CPU 201 determines that the speaker is the same person as the writer (the same person who speaks “today”), the display control unit 24 displays “(1)” in the same font size as that of “Today's agenda” at the position of the voice input mark 404 and moves the voice input mark 404 to the right of the character string “(1)”.

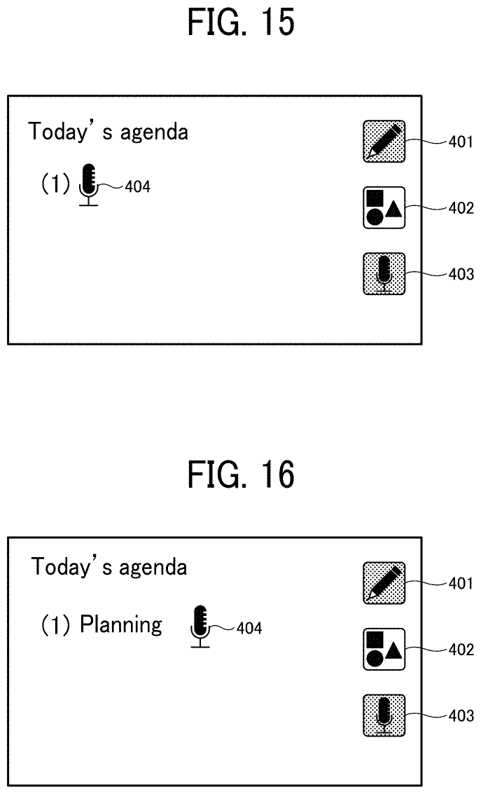

FIG. 15 illustrates the voice input mark 404 displayed to the right of “(1)”. Thus, the voice input mark 404 is moved to the right of text data obtained by speech recognition.

Subsequently, when a speaker (e.g., a chairperson) speaks “planning”, the CPU 201 performs the same or the substantially the same processes as described above, and the display control unit 24 displays “Planning” in the same font size as “(1)” to the right of the character string “(1)” and moves the voice input mark 404 to the right of the character string “Planning”.

FIG. 16 illustrates an example of screen on which text data “Planning” and the voice input mark 404 are displayed to the right of “(1)”. Thus, the voice input mark 404 is moved to the right of text data obtained by speech recognition in sequence.

Although in the present embodiment, the description given above is of an example in which the display apparatus 2 moves the voice input mark 404 in response to a drag and drop operation by the writer, this is merely one example. In another example, the display apparatus 2 moves the voice input mark 404 in response to a command input by voice. For example, in a case that a command “line feed” is registered in advance and text data converted from voice data of the writer matches “line feed”, the display control unit 24 moves the voice input mark 404 to a line head (creates a new line).

The display apparatus 2 according to the second embodiment, in addition to effects of the first embodiment, changes a display position of text data obtained by speech recognition by moving the voice input mark 404 in response to the writer's operation.

### Third Embodiment

In the present embodiment, a display system 19 is described in which a server apparatus 12 performs character recognition and speech recognition. Aspects of the first embodiment, aspects of the second embodiment, and aspects of the third embodiment can be combined as appropriate.

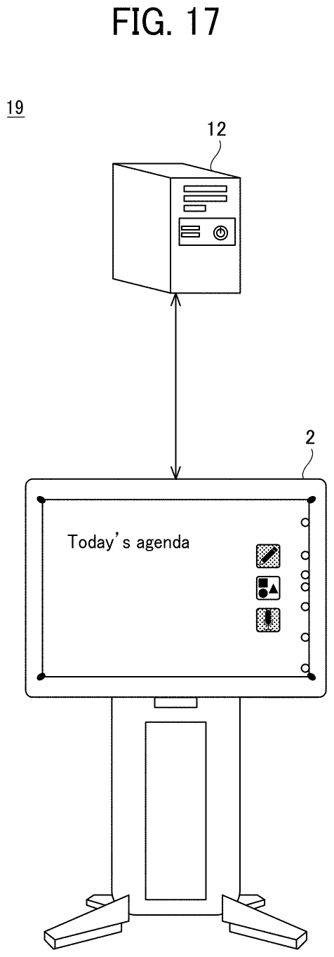

FIG. 17 is a schematic diagram illustrating an example of a configuration of the display system 19 according to the third embodiment. The display apparatus 2 and the server apparatus 12 are connected to each other through a network such as the Internet.

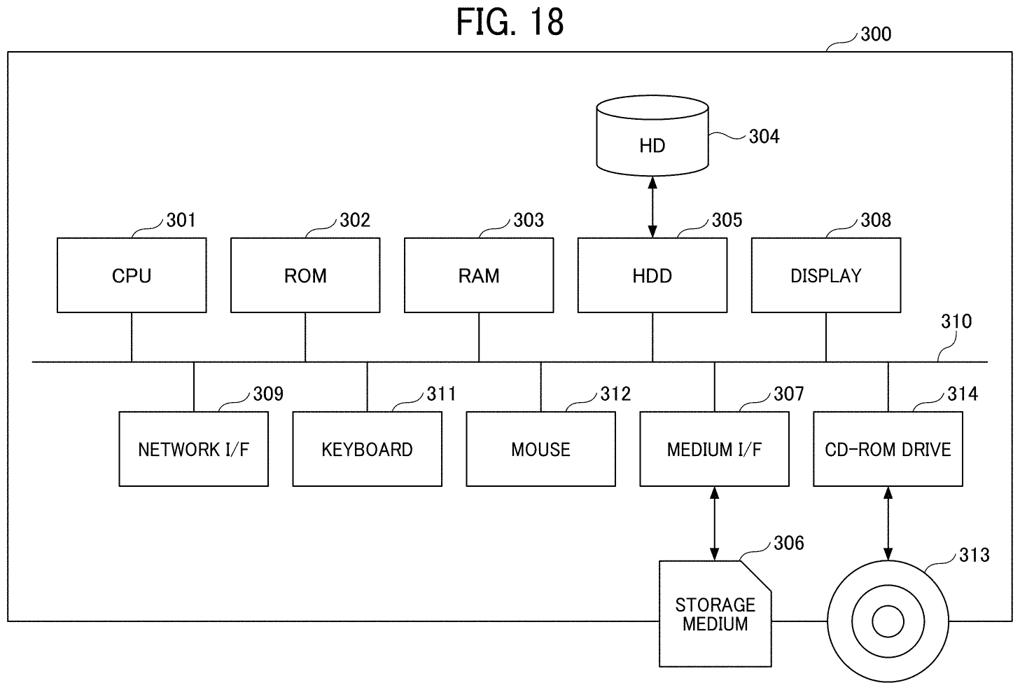

FIG. 18 is a block diagram illustrating an example of a hardware configuration of the server apparatus 12. The server apparatus 12 includes a CPU 301, a ROM 302, a RAM 303, a hard disk (HD) 304, a hard disc drive (HDD) 305, a storage medium 306, a medium I/F 307, a display 308, a network I/F 309, a keyboard 311, a mouse 312, a compact-disc read only memory (CD-ROM) drive 314, and a bus line 310.

The CPU 301 controls overall operation of the server apparatus 12. The ROM 302 stores a program such as an initial program loader (IPL) to boot the CPU 301. The RAM 303 is used as a work area for the CPU 301. The HD 304 stores various data such as a program. The HDD 305 controls reading and writing of data from and to the HD 304 under control of the CPU 301.

The medium I/F 307 reads and/or writes (stores) data from and/or to the storage medium 306 such as a flash memory. The display 308 displays various information such as a cursor, a menu, a window, a character, or an image. The network I/F 309 is an interface that controls communication of data through the network.

The keyboard 311 is an example of an input device provided with a plurality of keys that allows a user to input characters, numerals, or various instructions. The mouse 312 is an example of an input device that allows a user to select or execute various instructions, select an item to be processed, or move the cursor being displayed. The CD-ROM drive 314 reads and writes various data from and to a CD-ROM 313, which is an example of a removable storage medium. The bus line 310 is an address bus or a data bus, which electrically connects the hardware resources illustrated in FIG. 18 such as the CPU 301.

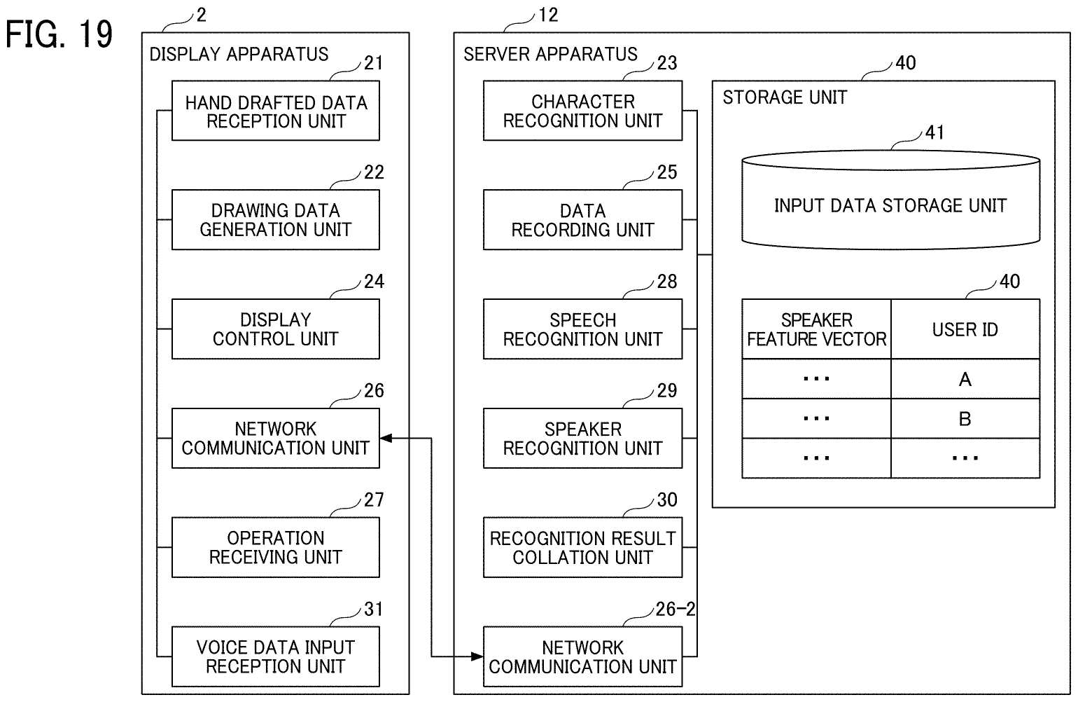

FIG. 19 is a block diagram illustrating an example of functional configurations of the display apparatus 2 and the server apparatus 12 according to the present embodiment. The functions of the display apparatus 2 are the hand drafted data reception unit 21, the drawing data generation unit 22, the display control unit 24, the network communication unit 26, the operation receiving unit 27, and the voice data input reception unit 31.

The server apparatus 12 includes the character recognition unit 23, the data recording unit 25, the speech recognition unit 28, the speaker recognition unit 29, the recognition result collation unit 30, and a network communication unit 26-2. The functions of the server apparatus 12 are implemented by or that are caused to function by operating any of the hardware components illustrated in FIG. 18 in cooperation with instructions of the CPU 301 according to the program expanded from the HD 304 to the RAM 303.

The network communication unit 26 of the display apparatus 2 transmits hand drafted data and voice data to the server apparatus 12. The server apparatus 12 performs the same or substantially the same processes as those described above referring to the flowcharts of FIG. 12A and FIG. 12B, and transmits text data input by voice by a writer to the display apparatus 2.

Thus, in the display system 19, the display apparatus 2 and the server apparatus 12 interactively display text data.

Variations:

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

In the embodiments, the description given above is of an example in which a single writer inputs hand drafted data. In another example, multiple writers input hand drafted data concurrently. After the processes of identifying of a writer based on the match between a speaker feature vector and text data as described above referring to steps S2 to S11 of FIG. 12A is performed individually for a first writer and a second writer, even if the first writer and the second writer concurrently perform hand drafting and speak, text data based on the first writer's speech is input next to text data hand drafted by the first writer, and text data based on the second writer's speech is input next to text data hand drafted by the second writer.

The description given above is of an example of the display apparatus 2 is used as an electronic whiteboard in the embodiments. In another example, any other suitable device is used as the display apparatus 2, provided that the device displays an image, such as a digital signage. In still another example, instead of the display apparatus 2, a projector may perform displaying. In this case, the display apparatus 2 may detect the coordinates of the tip of the pen using ultrasonic waves, instead of detecting the coordinates of the tip of the pen using the touch panel as described in the above embodiments. The pen emits an ultrasonic wave in addition to the light, and the display apparatus 2 calculates a distance based on an arrival time of the sound wave. The display apparatus 2 determines the position of the pen based on the direction and the distance. The projector draws (projects) the trajectory of the pen as a stroke.

In alternative to the electronic whiteboard of the embodiments described above, the present disclosure is applicable to any information processing apparatus with a touch panel. An apparatus having the same or substantially the same capabilities as those of an electronic whiteboard is also called an electronic information board or an interactive board. Examples of the information processing apparatus with a touch panel include, but not limited to, a projector (PJ), a data output device such as a digital signage, a heads-up display (HUD), an industrial machine, an imaging device such as a digital camera, an audio collecting device, a medical device, a networked home appliance, a laptop computer, a mobile phone, a smartphone, a tablet terminal, a game console, a personal digital assistant (PDA), a wearable PC, and a desktop PC.

The functional configuration of the display apparatus 2 are divided into the functional blocks as illustrated in FIG. 4, for example, based on main functions of the display apparatus, in order to facilitate understanding the processes performed by the display apparatus. The scope of the present disclosure is not limited by how the process units are divided or by the names of the process units. The processes implemented by the display apparatus 2 may be divided to a larger number of processes depending on the contents of processes. Further, one process may be divided to include the larger number of processes.

The functions of the server apparatus 12 may be distributed over multiple servers. In another example, the display system 19 may include multiple server apparatuses 12 that operate in cooperation with one another.

The functionality of the elements disclosed in the embodiments may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

According to one or more embodiments, a non-transitory computer-executable medium storing a program storing instructions is provided, which, when executed by one or more processors of a display apparatus, causes the one or more processors to perform a method. The method includes receiving an input of hand drafted data with an input device. The method includes converting the hand drafted data into first text data. The method includes receiving an input of first voice data. The method includes converting the first voice data into second text data. The method includes displaying third text data converted from second voice data in a case that the first text data and the second text data match each other at least in part.

In the related art, determination is not performed whether text data obtained by performing character recognition on hand drafted input data matches text data obtained by performing speech recognition on speech.

According to one or more embodiments of the present disclosure, a display apparatus is provided that determines whether text data obtained by performing character recognition on hand drafted input data matches text data obtained by performing speech recognition on speech.

According to a first aspect of the present disclosure, a display apparatus includes circuitry. The circuitry receives an input of hand drafted data with an input device.

The circuitry converts the hand drafted data into first text data. The circuitry receives an input of first voice data. The circuitry converts the first voice data into second text data. The circuitry displays, on a display, third text data converted from second voice data in a case that at least the first text data and the second text data match each other at least in part.

According to a second aspect of the present disclosure, in the display apparatus of the above first aspect, in a case that the first text data and the second text data match each other at least in part, the circuitry displays the third text data next to the first text data.

According to a third aspect of the present disclosure, in the display apparatus of the above first aspect or second aspect, the circuitry collates feature information extracted from the first voice data with feature information of voice data registered in advance for each user within a certain time period after the circuitry displays the first text data, to recognize a speaker who has spoken the first voice data. In a case that the recognized speaker is a writer who has written the first text data, the circuitry converts voice data of the writer into the second text data.

According to a fourth aspect of the present disclosure, in the display apparatus of the above third aspect, in a case that the second voice data received by the circuitry after the circuitry coverts the first voice data to the second text data is identified as the voice data of the recognized writer, the circuitry displays the third text data converted from the second voice data next to the first text data.

According to a fifth aspect of the present disclosure, in the display apparatus of any one of the above first to fourth aspects, the circuitry determines a size of the first text data based on a size of the hand drafted data of which the input is received by the circuitry. The circuitry displays the third text data in a size based on the size of the first text data.

According to a sixth aspect of the present disclosure, in the display apparatus of the above third aspect, in a case that the first text data converted from the hand drafted data and the second text data converted from the first voice data match each other at least in part, the circuitry displays a mark next to an end of the first text data.

According to a seventh aspect of the present disclosure, in the display apparatus of the above sixth aspect, in a case that the circuitry displays the third text data next to the first text data, the circuitry displays the mark next to the end of the third text data.

According to an eighth aspect of the present disclosure, in the display apparatus of the above sixth aspect or the above seventh aspect, the circuitry receives an operation of moving the mark to a desired position on the display with the input device. The circuitry displays text data converted from the voice data of the recognized writer at a position of the moved mark.

1. A display apparatus comprising circuitry configured to:
receive an input of hand drafted data with an input device;
convert the hand drafted data into first text data;
receive an input of first voice data;
convert the first voice data into second text data; and
display, on a display, third text data converted from second voice data in a case that the first text data and the second text data match each other at least in part.

2. The display apparatus of claim 1, wherein
in a case that the first text data and the second text data match each other at least in part, the circuitry displays the third text data next to the first text data.

3. The display apparatus of claim 1, wherein the circuitry is further configured to:
collate feature information extracted from the first voice data with feature information of voice data registered in advance for each user within a certain time period after the circuitry displays the first text data, to recognize a speaker who has spoken the first voice data; and
in a case that the recognized speaker is a writer who has written the first text data, convert voice data of the writer into the second text data.

4. The display apparatus of claim 3, wherein
in a case that the second voice data received by the circuitry after the circuitry converts the first voice data to the second text data is identified as the voice data of the writer, the circuitry displays the third text data converted from the second voice data next to the first text data.

5. The display apparatus of claim 1, wherein the circuitry is further configured to:
determine a size of the first text data based on a size of the hand drafted data of which the input is received by the circuitry; and
display the third text data in a size based on the size of the first text data.

6. The display apparatus of claim 3, wherein
in a case that the first text data converted from the hand drafted data and the second text data converted from the first voice data match each other at least in part, the circuitry displays a mark next to an end of the first text data.

7. The display apparatus of claim 6, wherein
in a case that the circuitry displays the third text data next to the first text data, the circuitry displays the mark next to the end of the third text data.

8. The display apparatus of claim 6, wherein the circuitry is further configured to:
receive an operation of moving the mark to a desired position on the display with the input device; and
display text data converted from the voice data of the writer at a position of the moved mark.

9. A display system comprising circuitry configured to:
receive an input of hand drafted data with an input device;
convert the hand drafted data into first text data;
receive an input of first voice data;
convert the first voice data into second text data; and
display, on a display, third text data converted from second voice data in a case that the first text data and the second text data match each other at least in part.

10. A display method comprising:
receiving an input of hand drafted data with an input device;
converting the hand drafted data into first text data;
receiving an input of first voice data;
converting the first voice data into second text data; and
displaying, on a display, third text data converted from second voice data in a case that the first text data and the second text data match each other at least in part.
